(19) United States
(12) Patent Application Publication
(10) Pub. No.: US 2015/0260056 A1
(43) Pub. Date: Sep. 17, 2015

(54) TURBOCHARGED INTERNAL COMBUSTION ENGINE WITH A "V" CONFIGURATION OF THE CYLINDERS FEATURING THE DEACTIVATION OF A BANK OF CYLINDERS DURING THE LOW-LOAD OPERATION

(71) Applicant: Ferrari S.p.A., Modena (IT)

(72) Inventor: Massimo MEDDA, Sassuolo (IT)

(73) Assignee: Ferrari S.p.A., Modena (IT)

(21) Appl. No.: 14/657,340

(22) Filed: Mar. 13, 2015

(30) Foreign Application Priority Data
Mar. 14, 2014 (IT) BO2014A000127

(51) Int. Cl. F01D 25/18; F02B 37/007; F02D 41/00; F02D 17/02; F02B 75/22

(52) U.S. Cl. CPC F01D 25/18; F02D 17/02; F02B 75/22; F02D 41/0007; F02B 37/007; F05D 2220/40

(57) ABSTRACT

An internal combustion engine having: a plurality of cylinders, which are arranged in two banks arranged at an angle relative to one another; for each bank of cylinders, a corresponding turbocharger having a lubrication circuit, which is provided with a delivery duct to feed lubricating oil under pressure into the turbocharger; and a control unit, which is suited to deactivate the cylinders of one of the two banks during the low-load operation, and to interrupt the feeding of lubricating oil to the turbocharger, when the corresponding bank of cylinders is deactivated.

### BACKGROUND OF THE INVENTION

1. Field of the Invention

The present invention relates to a turbocharged internal combustion engine with a “V” configuration of the cylinders featuring the deactivation of a bank of cylinders during the low-load operation.

2. Description of the Related Art

An internal combustion engine for motor vehicles normally comprises a plurality of cylinders, which are either arranged straight on a single bank or are divided into two banks at an angle relative to each other. Generally, engines which have a relatively small displacement (typically up to two liters) have a limited number of cylinders (normally four, but also three or five) arranged straight on a single bank; on the contrary, engines which have a large displacement (more than two liters) have a higher number of cylinders (six, eight, ten or twelve) divided into two banks which are arranged at an angle relative to each other (the angle between the banks is generally comprised between 60° and 180°).

A large displacement engine (more than two liters) can generate a high maximum power, which however is rarely exploited during normal driving on the road; particularly when driving in cities, the engine must generate a very limited power which, in the case of a large displacement engine, is a limited fraction of the maximum (or rated) power. Inevitably, when a high displacement engine delivers limited power (i.e. operates at low load), such a power is delivered with a relatively low energy efficiency and with higher emission of pollutants because the total displacement is greatly oversized.

In an internal combustion engine, it has been suggested to deactivate some (generally half) of the cylinders when the engine is required to generate limited power (i.e. when it operates at low load); in this manner, the cylinders which remain operational may operate in more favorable conditions, thus increasing the total energy efficiency and reducing the emission of pollutants. In particular, one bank (corresponding to half the cylinders in the engine) is deactivated in an internal combustion engine in which the cylinders are divided into two banks arranged at an angle relative to each other; in other words, all and only the cylinders of the same bank are deactivated in internal combustion engines with cylinders arranged in a “V” configuration and divided into two banks during low-load operation.

In accordance with the currently known method, in order to deactivate a cylinder, injection into the cylinder is cut off (i.e. the corresponding injector is not controlled) and both the corresponding intake valves and the corresponding exhaust valves remain closed (the mechanical compression work of the gas inside the cylinders operated during the step of compression is surrendered elastically, minus negligible loss during the step of expansion).

Patent application DE102010060110A1 describes an internal combustion engine comprising a plurality of cylinders which are arranged on two banks, each of which is provided with its own turbocharger, which is independent and separate from the turbocharger of the other bank.

### SUMMARY OF THE INVENTION

It is the object of the present invention to supply a turbocharged internal combustion engine with a “V” configuration of the cylinders featuring the deactivation of a bank of cylinders during the low-load operation, which internal combustion engine has high reliability over time and is easy and cost-effective to make at the same time.

According to the present invention, a turbocharged internal combustion engine with a “V” configuration of the cylinders featuring the deactivation of a bank of cylinders during the low-load operation is provided as claimed in the appended claims.

### BRIEF DESCRIPTION OF THE DRAWINGS

The present invention will now be described with reference to the accompanying drawings, which show a non-limitative embodiment thereof, in which:

FIG. 1 is a diagrammatic view of a turbocharged internal combustion engine with a “V” configuration of the cylinders featuring the deactivation of a bank of cylinders during the low-load operation object of the present invention; and

FIG. 2 is a diagrammatic and longitudinal section view of a turbocharger of the internal combustion engine in FIG. 1.

### PREFERRED EMBODIMENTS OF THE INVENTION

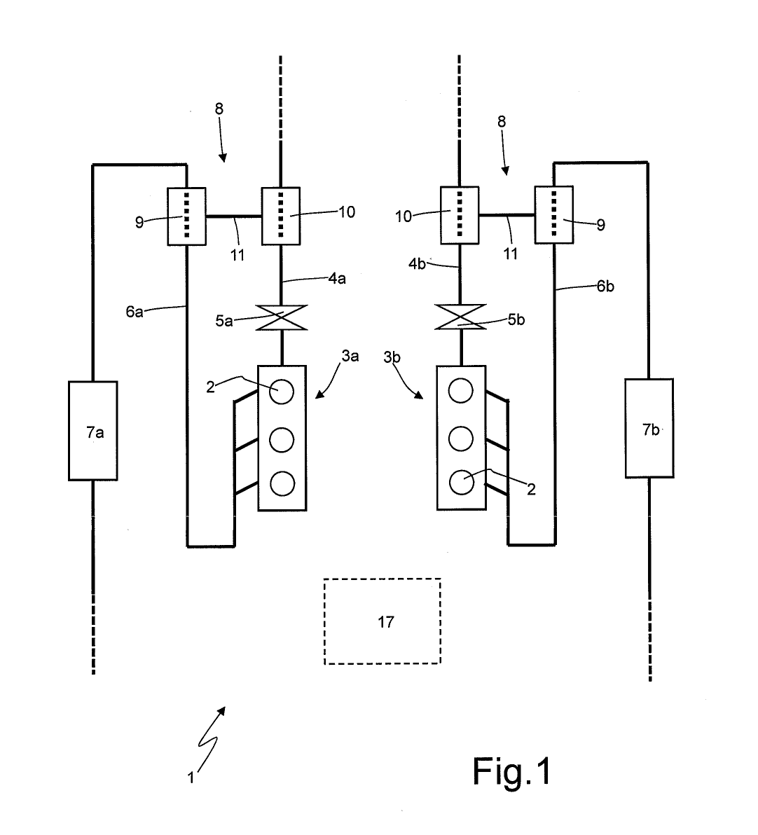

In the FIG. 1, reference numeral 1 indicates an internal combustion engine for a motor vehicle (not shown) as a whole.

The internal combustion engine 1 comprises six cylinders 2 arranged on two banks 3a and 3b which form an angle of 90° relative to each other (obviously, the number of cylinders 2 and/or the angle between the two banks 3a and 3b could be different). The engine 1 also comprises an intake duct 4a and an intake duct 4b, which are connected to cylinders 2 of bank 3a and to cylinders 2 of bank 3b, respectively, and are controlled by a throttle valve 5a and a throttle valve 5b, respectively. In particular, the cylinders 2 of bank 3a are connected to intake duct 4a by means of a corresponding intake manifold, and the cylinders 2 of bank 3b are connected to intake duct 4b by means of a corresponding intake manifold.

The cylinders 2 of bank 3a are connected to an exhaust conduit 6a by means of a corresponding exhaust manifold, and the cylinders 2 of bank 3b are connected to an exhaust duct 6b by means of a corresponding exhaust manifold. Each exhaust duct 6a or 6b conveys the exhaust gases ejected from the cylinders 2 of its bank 3a or 3b towards a catalytic system 7a or 7b of known type.

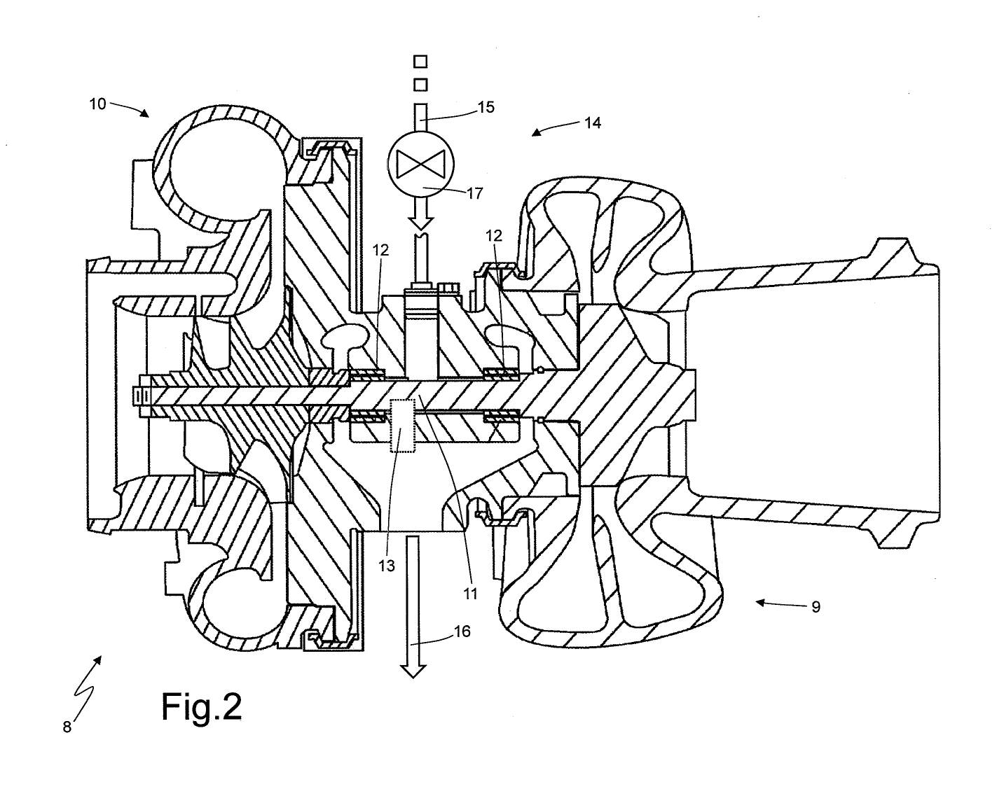

Furthermore, each bank 3a and 3b comprises a corresponding turbocharger 8, which supercharges the fresh intake air to increase the volumetric efficiency of the corresponding cylinders 2 and comprises a turbine 9 arranged along the exhaust duct 6a or 6b or a compressor 10 arranged along the intake duct 4a or 4b. As shown in FIG. 2, each turbocharger 8 comprises a shaft 11, which is rotationally mounted on bearing 12 thereof and which supports the turbine 9 on one end and supports the compressor 10 on the opposite end. According to a possible, non-binding embodiment, a speed sensor 13 of known type, which detects the rotation speed of the shaft 11 itself, is coupled to each shaft 11.

Each turbocharger 8 comprises a lubrication circuit 14 (only partially and diagrammatically shown in FIG. 2), which in use feeds lubricating oil under pressure into the turbocharger 8, in particular to maintain the bearings 12 of the shaft 11 (which rotates at very high rotation speeds, in the order of hundreds of thousand revolutions per minute) appropriately lubricated. The lubrication circuit 14 of each turbocharger 8 comprises a lubricating oil delivery duct 15, through which the lubricating oil under pressure is fed into the turbocharger 8, and a return pipe 16, through which the lubricating oil coming from the turbocharger 8 is recirculated. Typically, the lubrication circuits 14 of the turbochargers 8 are connected to the main lubrication circuit of the internal combustion engine 1 with which they share the lubricating oil.

The delivery ducts 15 of the two turbochargers 8 receive lubricating oil under pressure from a lubrication pump (known and not shown), which is normally rotated by the drive shaft of the internal combustion engine 1, and thus is always active when the internal combustion engine 1 is on (i.e. is turning). In each turbocharger 8 in use, the lubricating oil under pressure fed by the corresponding delivery pipe 15 enters into a housing of the bearings 12 (arranged centrally between the turbine 9 and the compressor 10) and thus axially migrates about the shaft 11 in both directions to reach the bearings 12; when the lubricating oil reaches the bearings 12 it is forced to flow through a plurality of lubrication paths arranged about the bearings 12 which end in annular collection spaces arranged about the bearings 12 and from there the lubricating oil descends by gravity into a lower collection sump, from where the return pipe 16 originates.

An electrically actuated shut-off valve 17, which is adapted to open and close the delivery duct 15 to interrupt when necessary the flow of lubricating oil which flows along the delivery duct 15 towards the corresponding turbocharger 8, is arranged along each delivery duct 15.

Finally, as shown in FIG. 1, the internal combustion engine 1 comprises an electronic control unit 18, which governs the operation of the internal combustion engine 1, and in particular can turn off all and only the cylinders 2 of one of the two banks 3a and 3b when the internal combustion engine 1 is required to generate a limited power (i.e. when the internal combustion engine 1 is in low-load conditions). In this manner, the cylinders 2 which remain active (i.e. the cylinders 2 of the bank 3a or 3b which was not deactivated) may operate in more favorable conditions by increasing the overall efficiency of the internal combustion engine 1 and reducing the emission of pollutants, the delivered power being equal.

During the operation of the internal combustion engine 1, the electronic control unit 18 decides whether to use all cylinders 2 to generate the torque, or whether to turn off (deactivate) some of the cylinders 2 (i.e. all and only the cylinders 2 of one of the two banks 3a and 3b) and therefore use only some of the cylinders 2 (i.e. the cylinders 2 of the bank 3a and 3b which was not deactivated) to generate the torque. Generally, some of the cylinders 2 are deactivated (turned off) when the internal combustion engine 1 is required to generate a limited power and the power request is not expected to increase on the short term.

Preferably, the cylinders 2 of one of the two banks 3a and 3b are deactivated by cutting off the fuel injection and keeping the corresponding intake and exhaust valves closed by means of a deactivation system (known and not shown) of the valves themselves, which deactivation system, for example, could include the use of collapsible tappets, the use of a “cam-changing” device, or the use of collapsible fingers.

When the control unit 18 deactivates the cylinders 2 of one of the two banks 3a or 3b during the low-load operation, the control unit 18 includes cutting off the feeding of lubricating oil to the corresponding turbocharger 8 at the same time by closing the shut-off valve 17; in other words, the control unit 18 interrupts the feeding of lubricating oil to the turbocharger 8, thus closing the shut-off valve 17 when the corresponding bank 3a or 3b of the cylinders 2 is deactivated. Consequently, the control unit 18 interrupts the feeding of lubricating oil to a turbocharger 8 when the corresponding bank 3a or 3b of cylinders 2 is deactivated and reopens the feeding of lubricating oil to the turbocharger 8 when the corresponding bank 3a or 3b of cylinders 2 is reactivated.

According to a possible embodiment, the control unit 18 controls the shut-off valve 17 of the bank 3a or 3b of cylinders 2 which are deactivated in completely independent manner from the actual rotation speed of the shaft 11 of the corresponding turbocharger 8; in this case, the control unit 18 interrupts the feeding of lubricating oil to the turbocharger 8 by closing the shut-off valve 17 after a first interval of time (determined experimentally, stored in a table and generally variable according to the engine point) from the instant of deactivation of the bank 3a or 3b of the cylinders 2 and resuming the feeding of lubricating oil to the turbocharger 8 by opening the shut-off valve 17 after a second interval of time (experimentally determined, stored in a table and variable as a function of the engine point) from the instant of reactivation of the bank 3a or 3b of the cylinders 2. The closing/opening action on the shut-off valve 17 of the corresponding turbocharger 8 is (slightly) delayed with respect to the deactivation/reactivation of the bank 3a or 3b of the cylinders 2 to take the lag (i.e. the inertia) of the turbocharger 8 into account. As mentioned, in this embodiment the actual rotation speed of the shaft 11 of the corresponding turbocharger 8 is not taken into account when a bank 3a or 3b of cylinders 2 is deactivated.

According to an alternative embodiment, the control unit 18 controls the shut-off valve 17 of the bank 3a or 3b of cylinders 2 which bank is deactivated as a function of the actual rotation speed of the shaft 11 of the corresponding turbocharger 8; in this case, the control unit 18 interrupts the feeding of lubricating oil to the turbocharger 8 by closing the shut-off valve 17 when after deactivating the bank 3a or 3b of cylinders 2, the rotation speed of the shaft 11 of the corresponding turbocharger 8 drops under a closing threshold, and the control unit 18 resumes the feeding of lubricating oil by opening the shut-off valve 17 when, after reactivating the bank 3a or 3b of cylinders 2, the rotation speed of the shaft 11 of the corresponding turbocharger 8 rises over an opening threshold.

The control unit 18 may directly determine the rotation speed of the shaft 11 of each turbocharger 8 using the corresponding the speed sensor 13 or in absence of the speed sensor 13, the control unit 18 may indirectly determine the rotation speed of the shaft 11 of each turbocharger 8 using estimation algorithms based, for example, on the air pressure inside the corresponding intake duct 4.

According to a preferred embodiment, the control unit 18 does not always deactivate the same bank 3a or 3b of cylinders 2, but alternates deactivations between the two banks 3a and 3b of cylinders 2 so as to distribute wear symmetrically on both the banks 3a and 3b of cylinders 2; consequently, the lubrication circuits 14 are provided with shut-off valves 17 in both turbochargers 8. Alternatively, the control unit 18 always deactivates the same bank 3a or 3b of cylinders 2, and thus only the lubrication circuit 14 of the corresponding turbocharger 8 is provided with the shut-off valve 17.

The internal combustion engine 1 described above has many advantages.

Firstly, the internal combustion engine 1 described above allows to obtain high reliability of the turbochargers 8 over time by avoiding excessive stress on the turbochargers 8 themselves caused by infiltrations of lubricating oil in zones of the turbochargers 8 in which the lubricating oil should not be present; indeed, it has been observed that the sealing elements of each turbocharger 8 which should confine the lubrication oil and which are arranged at the bearings 12 provide excellent dynamic sealing (i.e. when the shaft 11 rotates), but provide a less effective static sealing (i.e. when the shaft 11 is stationary), thus if the lubricating oil under pressure is fed when the turbocharger 8 is completely stationary (or when the corresponding bank 3a or 3b of cylinders 2 is deactivated) undesired, potentially harmful infiltrations of lubricating oil could occur through the sealing elements. Instead, in accordance with the present invention, the feeding of lubricating oil under pressure to the turbocharger 8 is interrupted when the corresponding bank 3a or 3b of cylinders 2 is deactivated and thus the possibility of undesired, potentially harmful infiltrations of lubricating oil occurring into the turbocharger 8 through the sealing elements when the turbocharger 8 is stopped is entirely avoided.

Furthermore, the internal combustion engine 1 described above is simple and cost-effective to make with respect to a similar known internal combustion engine because the only additional physical elements with respect to a similar known internal combustion engine are the two shut-off valves 17, which have a modest cost.

What is claimed is:

1. An internal combustion engine comprising:
a plurality of cylinders, which are arranged in two banks arranged at an angle relative to one another;
for each bank Of cylinders, a corresponding turbocharger having a lubrication circuit, which comprises a delivery duct to feed lubricating oil under pressure into the turbocharger; and
a control unit, which is suited to deactivate the cylinders of one of the two banks during the low-load operation;
wherein the control unit interrupts the feeding of lubricating oil to the turbocharger when the corresponding bank of cylinders is deactivated.

2. An internal combustion engine according to claim 1, wherein the lubrication circuit of at least one turbocharger comprises a shut-off valve, which is arranged along the corresponding delivery duct, and is suited to open and close the delivery duct so as to interrupt the flow of lubricating oil, and is closed by the control unit when the corresponding bank of cylinders is deactivated.

3. An internal combustion engine according to claim 1, wherein the control unit interrupts the feeding of lubricating oil to a turbocharger when the corresponding bank of cylinders is deactivated, and resumes the feeding of lubricating oil to the turbocharger when the corresponding bank of cylinders is reactivated.

4. An internal combustion engine according to claim 1, wherein the control unit determines the rotation speed of a shaft of the turbocharger of the bank of cylinders that was deactivated and interrupts the feeding of lubricating oil as a function of said rotation speed.

5. An internal combustion engine according to claim 4, wherein the control unit interrupts the feeding of lubricating oil, when, after the deactivation of a bank of cylinders, the rotation speed of the shaft of the corresponding turbocharger is below a closing threshold.

6. An internal combustion engine according to claim 4, wherein the control unit resumes the feeding of lubricating oil, when, after the reactivation of a bank of cylinders, the rotation speed of the shaft of the corresponding turbocharger exceeds an opening threshold.

7. An internal combustion engine according to claim 4, wherein each turbocharger comprises a speed sensor, which detects the rotation speed of the corresponding shaft and is connected to the control unit.

8. An internal combustion engine according to claim 4, wherein the control unit indirectly determines, by means of an estimation algorithm, the rotation speed of the shaft of a turbocharger.

9. A method to control an internal combustion engine comprising:
a plurality of cylinders, which are arranged in two banks arranged at an angle relative to one another; and
for each bank of cylinders, a corresponding turbocharger having a lubrication circuit, which comprises a delivery duct to feed lubricating oil under pressure into the turbocharger;
the control method comprising the steps of:
deactivating the cylinders of one of the two banks during the low-load operation; and
interrupting the feeding of lubricating oil to the turbocharger, when the corresponding bank of cylinders is deactivated.
